(19) United States
(12) Patent Application Publication
(10) Pub. No.: US 2017/0220671 A1
(43) Pub. Date: Aug. 3, 2017

(54) SYSTEM, METHOD, AND APPARATUS FOR COLLECTING AND PROCESSING USER FEEDBACK ON WEBPAGES

(71) Applicants: Nan ZHENG, Hangzhou, Zhejiang (CN); Alibaba Group Holding Limited, Grand Cayman (KY)

(72) Inventor: Nan ZHENG, Hangzhou (CN)

(21) Appl. No.: 15/501,665

(22) PCT Filed: Jul. 17, 2015
(86) PCT No.: PCT/CN2015/084300

§ 371 Date: Feb. 3, 2017

(30) Foreign Application Priority Data
Aug. 6, 2014 (CN) 201410384276.4

(51) Int. Cl. G06F 17/30

(52) U.S. Cl. CPC G06F 17/30648; G06F 17/30696; G06F 17/3089

(57) ABSTRACT

The disclosure discloses a method of collecting user feedback of webpages, including: receiving instructions of feedback operations on a current webpage; loading and displaying, based on the received instructions, a feedback webpage associated with the current webpage; receiving feedback input from a user regarding elements requiring feedback on the feedback webpage; generating a feedback collection interface based on the elements requiring feedback and the feedback input; and receiving the user feedback via the feedback collection interface, and collecting on-site information while receiving the user feedback. The method of collecting user feedback of webpages has low requirements for users, is convenient and simple to operate, and is highly targeted. The disclosure additionally provides a method for processing user feedback on webpages, simplifying the processing flow of user feedback and achieving higher efficiency in processing user feedback.

### CROSS-REFERENCE TO RELATED APPLICATIONS

This application claims the benefit of priority of Chinese Patent Application No. 201410384276.4, filed on Aug. 6, 2014 and PCT Application No. PCT/CN2015/084300, filed on Jul. 17, 2015, which are incorporated herein in their entirety by reference.

### BACKGROUND

### Technical Field

The following disclosure relates to the field of Web technologies, and in particular, to methods, apparatuses, and systems for collecting and processing user feedback on webpages.

### Description of Related Art

With the continuous development of network communication technologies, in order to receive users' feedback on webpages or on certain information of the webpages, most websites are provided with a special feedback function. Website construction is continuously improving according to user feedback, so as to further meet users' requirements and improve user experience. The implementation of a user feedback function mainly includes two steps: first, collection of user feedback; and second, processing of the collected user feedback.

In the prior art, user feedback on webpages is collected mainly through user description (including a text description or other description), a combination of user description and image review (e.g., screenshots), or the like. In the existing methods of processing user feedback, feedback processing personnel organize and classify summarized user feedback and perform further distribution and processing according to types of user feedback, such as filtering out invalid feedback, forwarding feedback for online questions to developers for processing, forwarding feedback for new requirements to product personnel for processing, and forwarding feedback for questions on query usage to personnel specialized in search technologies for processing. The personnel who receive the feedback process the feedback and return their results to feedback processing personnel. The feedback processing personnel, in turn, return the obtained processing results to users in a unified way.

Current techniques for collecting user feedback on webpages set a higher standard for users in that not only the content of the user feedback should be unambiguous with an accurate description, the image description (e.g., screenshots) should also be captured correctly through tools provided by the website, imposing a high standard on users. Moreover, received feedback is poorly targeted, and thus difficult for a user to provide targeted feedback on a certain element of a webpage. Additionally, current techniques for processing user feedback on webpages require much more communication when processing user feedback, and have a complex process with low processing efficiency.

### BRIEF SUMMARY

The disclosure describes systems, methods, and apparatuses for collecting and processing user feedback on webpages, so as to solve the problems in the prior art, that is, placing a high standard on users, generating poorly targeted feedback, and lowering processing efficiency.

The disclosure also relates to an apparatus for collecting user feedback on webpages, an apparatus for processing user feedback on webpages, and a system for collecting and processing user feedback on webpages.

Disclosed is a method of collecting user feedback of webpages, including: receiving instructions of feedback operations on a current webpage; loading and displaying, based on the received instructions, a feedback webpage associated with the current webpage; receiving feedback input from a user regarding elements requiring feedback on the feedback webpage; generating a feedback collection interface based on the elements requiring feedback and the feedback input; and receiving the user feedback via the feedback collection interface, and collecting on-site information while receiving the user feedback.

Optionally, receiving instructions of feedback operations on a current webpage may comprise: receiving an operation instruction on the webpage; determining whether the operation instruction triggers a preset feedback action or feedback identifier of the webpage; and if the operation instruction triggers the preset feedback action or feedback identifier of the webpage, determining the operation instruction as a feedback operation instruction sent by the user for the current webpage and receiving the feedback operation instruction.

Optionally, loading and displaying, based on the received instructions, a feedback webpage associated with the current webpage may comprise: receiving, according to the feedback operation instruction, data resources required for loading the feedback webpage; and loading the data resources and generating the feedback webpage.

Optionally, the data resources comprise: data resources associated with elements requiring feedback on the feedback webpage; and background data resources, wherein the data resources associated with elements requiring feedback include: text data and multimedia data; and the background data resources include: scripts and hyperlinks.

Optionally, receiving, according to the feedback operation instruction, data resources required for loading the feedback webpage may be implemented via any one of the following methods: receiving, from a Web server, the data resources required for loading the feedback webpage; or receiving, based on a local memory storage, the data resources required for loading the feedback webpage; or receiving, based on both a Web server and a local memory storage, the data resources required for loading the feedback webpage.

Optionally, receiving, from a Web server, the data resources required for loading the feedback webpage includes: receiving the background data resources from the Web server while keeping the data resources associated with elements requiring feedback unchanged; or receiving the data resources associated with elements requiring feedback and the background data resources from the Web server.

Optionally, loading the data resources and generating the feedback webpage includes: creating a new webpage according to the feedback operation instruction, and loading the data resources according to the new webpage and generating the feedback webpage associated with the current webpage; or loading the data resources based on the webpage and displaying the feedback webpage associated with the current webpage.

Optionally, the receiving feedback input sent by a user for elements requiring feedback on the feedback webpage includes: receiving input of the user for elements requiring feedback on the feedback webpage; determining whether the input triggers a preset feedback action or feedback identifier of elements requiring feedback; and if the input triggers the preset feedback action or feedback identifier of elements requiring feedback, determining the input as feedback input sent by the user for elements requiring feedback on the feedback webpage and receiving the feedback input.

Optionally, the feedback collection interface includes: a feedback collecting page for collecting user feedback based on webpages, wherein the feedback collecting page may be implemented via any one of the following methods: creating a new webpage according to a current webpage window, and loading and displaying the feedback collecting page based on the new webpage; or creating a new webpage window, creating a new webpage according to the webpage window, and loading and displaying the feedback collecting page based on the new webpage; or loading and displaying the feedback collecting page based on the feedback webpage or the current webpage.

Optionally, the feedback includes text information, image information, and/or video information.

Optionally, the on-site information includes a user ID, feedback time, user operating system information, and/or browser information.

Optionally, the method includes submitting the feedback and the on-site information to a feedback processing end.

Optionally, submitting the feedback and the on-site information to a feedback processing end includes receiving a submission request sent by the user for the feedback, and submitting the feedback and the on-site information to the feedback processing end; and disabling the feedback collection interface.

Optionally, the disabling the feedback collection interface includes: after submitting the feedback and the on-site information to the feedback processing end, disabling the feedback collection interface; or after submitting the feedback and the on-site information to the feedback processing end, if receiving an interface disabling request sent by the user and the interface disabling request triggers a preset disabling action or disabling identifier of the feedback collection interface, disabling the feedback collection interface.

Additionally disclosed is an apparatus for collecting user feedback on webpages, comprising: an operation instruction receiving unit, configured to receive a feedback operation instruction sent by a user for a current webpage; a feedback webpage loading unit, configured to load and display, based on the received instructions, a feedback webpage associated with the current webpage; a feedback input receiving unit, configured to receive feedback input from a user regarding elements requiring feedback on the feedback webpage; an interface generation unit, configured to generate a feedback collection interface based on the elements requiring feedback and the feedback input; and a feedback collecting unit, configured to receive the user feedback via the information feedback collection interface, and collect on-site information while receiving the user feedback.

Optionally, the operation instruction receiving unit includes an operation instruction receiving subunit, configured to receive an operation instruction sent by the user for the webpage; an operation instruction judging subunit, configured to judge whether the operation instruction triggers a preset feedback action or feedback identifier of the webpage; and if the operation instruction triggers the preset feedback action or feedback identifier of the webpage, move to a feedback operation instruction receiving subunit; and the feedback operation instruction receiving subunit, configured to determine the operation instruction as a feedback operation instruction sent by the user for the current webpage and receive the feedback operation instruction.

Optionally, the feedback input receiving unit includes: an input receiving subunit, configured to receive input from a user regarding elements requiring feedback on the feedback webpage; an input judging subunit, configured to judge whether the input triggers a preset feedback action or feedback identifier of elements requiring feedback; and if the input triggers the preset feedback action or feedback identifier of elements requiring feedback, move to a feedback input receiving subunit; and the feedback input receiving subunit, configured to determine the input as feedback input from the user regarding elements requiring feedback on the feedback webpage and receive the feedback input.

Optionally, the apparatus for collecting user feedback on webpages includes: a feedback submission unit, configured to submit the feedback and the on-site information to a feedback processing end.

Optionally, the feedback submission unit includes: an information submission subunit, configured to receive a submission request sent by the user for the feedback, and submit the feedback and the on-site information to the feedback processing end; and an interface disabling subunit, configured to disable the feedback collection interface.

Additionally disclosed is a method for processing user feedback on webpages, including: receiving feedback of a user and on-site information submitted by a feedback collecting end; determining a most precise area where elements requiring feedback associated with the feedback is located and a person in charge of the area; and receiving a processing result for the feedback associated with elements requiring feedback from the person in charge of the area.

Optionally, after the receiving feedback and on-site information submitted by a feedback collecting end, the method includes: judging whether a format of the feedback conforms to a preset format standard and/or whether the feedback matches elements requiring feedback; and if the format of the feedback conforms to the preset format standard and/or the feedback matches elements requiring feedback, determining a most precise area where elements requiring feedback associated with the feedback is located and a person in charge of the area.

Optionally, the method for processing user feedback on webpages includes: combining the feedback and the on-site information and sending the processing result to the user by email.

Additionally, disclosed is an apparatus for processing user feedback on webpages, including: a feedback receiving unit, configured to receive feedback of a user and on-site information submitted by a feedback collecting end; a feedback processing determining unit, configured to determine a most precise area where elements requiring feedback associated with the feedback is located and a person in charge of the area; and a feedback result receiving unit, configured to receive a processing result for the feedback associated with elements requiring feedback from the person in charge of the area.

Optionally, the apparatus for processing user feedback on webpages includes: a feedback judging unit, configured to judge whether a format of the feedback conforms to a preset format standard and/or whether the feedback matches elements requiring feedback; and if the format of the feedback conforms to the preset format standard and/or the feedback matches elements requiring feedback, move to the feedback processing determining unit.

Optionally, the apparatus for processing user feedback on webpages comprises a result feedback unit, configured to combine the feedback and the on-site information and send the processing result to the user by email.

The disclosure additionally provides a system for collecting and processing user feedback on webpages, comprising a feedback collecting end, comprising the apparatus for collecting user feedback on webpages as described above; and a feedback processing end, comprising the apparatus for processing user feedback on webpages as described above.

Compared with the prior art, the disclosure has the following advantages: the method of collecting user feedback of webpages provided in the disclosure sets lower standard for users, is convenient and simple to operate, and is highly targeted.

The method of collecting user feedback of webpages provided in the disclosure includes: receiving instructions of feedback operations on a current webpage; loading and displaying, based on the received instructions, a feedback webpage associated with the current webpage; receiving feedback input sent by a user for elements requiring feedback on the feedback webpage; generating a feedback collection interface based on the elements requiring feedback and the feedback input; and receiving the user feedback via the feedback collection interface, and collecting on-site information while receiving the user feedback.

By means of the method of collecting user feedback of webpages, a user enters a feedback webpage associated with a webpage through a preset feedback identifier of the webpage; the user can provide feedback for elements requiring feedback on the feedback webpage, and user feedback is collected through a feedback collecting page associated with elements requiring feedback, making the method simple to operate and highly targeted.

The method for processing user feedback on webpages provided in the disclosure has a simple process and high processing efficiency.

The method for processing user feedback on webpages provided in the disclosure includes: receiving feedback submitted by a user and on-site information during reception of the feedback and acquisition of the feedback; determining the validity of the feedback; if the feedback is determined as valid, determining an element associated with the feedback on the webpage; determining a minimum area where the element is located and a preset manager of the area; receiving the manager's processing result of the feedback; and sending the processing result to the user in a specific method.

By means of the method for processing user feedback on webpages, feedback submitted by a user and on-site information are filtered in a unified way; an element associated with the filtered feedback and a manager associated with the element are determined; the feedback is sent to the manager for processing, and a processing result is returned to the user. The method for processing user feedback on webpages in the disclosure simplifies the processing flow. Moreover, based on the area where an element on the feedback webpage is located, a manager associated with the area is set. When user feedback is observed for a certain element on the feedback webpage, the feedback submitted by the user is sent to the corresponding manager for processing, thereby achieving higher efficiency in processing user feedback.

### BRIEF DESCRIPTION OF THE DRAWINGS

FIG. 1 is a flow diagram illustrating a method for collecting user feedback of webpages according to some embodiments of the disclosure.

FIG. 2 is a block diagram illustrating an apparatus for collecting user feedback on webpages according to some embodiments of the disclosure.

FIG. 3 is a flow diagram illustrating a method for processing user feedback on webpages according to some embodiments of the disclosure.

FIG. 4 is a block diagram illustrating an apparatus for processing user feedback on webpages according to some embodiments of the disclosure.

FIG. 5 is a block diagram illustrating a system for collecting and processing user feedback on webpages according to some embodiments of the disclosure.

### DETAILED DESCRIPTION

Many specific details are set forth in the following description to facilitate full understanding of the disclosure. However, the disclosure can be implemented in many other manners other than those described herein. Those skilled in the art can make similar deduction without departing from the essence of the disclosure, and therefore the disclosure is not limited by the specific implementation disclosed below.

The disclosure provides methods, systems, and apparatuses, for collecting and processing user feedback on webpages, so as to solve the problems in the prior art, including a high standard set for users, poorly targeted feedback, and low processing efficiency. The disclosure also relates to an apparatus for collecting user feedback on webpages, an apparatus for processing user feedback on webpages, and a system for collecting and processing user feedback on webpages.

An embodiment of methods of collecting user feedback of webpages is as follows.

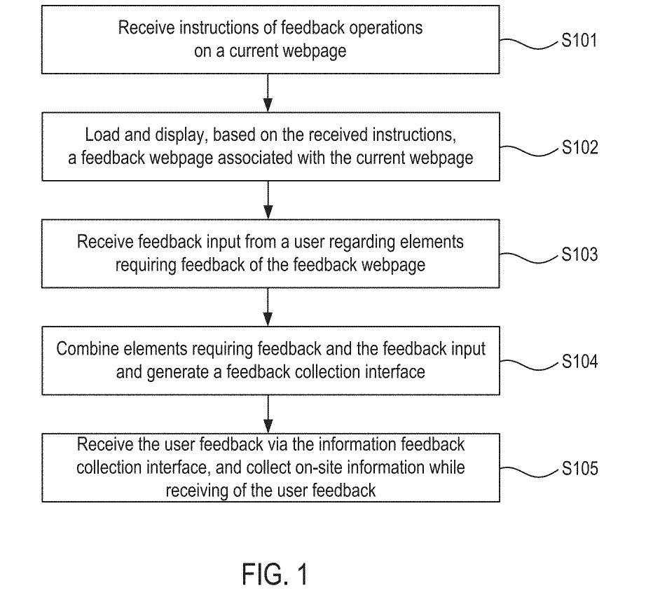

FIG. 1 is a flow diagram illustrating a method for collecting user feedback of webpages according to some embodiments of the disclosure.

In the illustrated embodiment, a user's feedback on a commodity on a shopping website is used and described as an example.

The illustrated method for collecting user feedback of webpages includes the following steps:

S101: Receive instructions of feedback operations on a current webpage.

The most convenient way for a user to find a targeted commodity on a shopping website is to perform a search using the search engine provided by the shopping website. The user enters a keyword and performs a search using the search engine to generate a search result page. Afterwards, the user browses the found commodities on the search page and finds the targeted commodity that the user plans to purchase. Upon encountering a problem on a certain webpage during the search, the user has a need to provide feedback for the webpage and may provide feedback for the webpage in various manners. In this embodiment, the current webpage includes a search result page. Steps of providing feedback for the search result page by the user are as follows.

1) Receiving an operation instruction for the webpage.

The operation instruction refers to an operation performed on the webpage (namely, the search result page) through a peripheral such as a mouse, a keyboard, or a terminal, including a click operation, an input operation, and so on.

It should be noted that the step of receiving an operation instruction on the webpage includes not only passively receiving an operation instruction sent by the user for the search result page, but also includes actively receiving other operation instructions other than the operation instruction sent by the user. For example, when a mouse arrow hovers over an area associated with a certain commodity on the search result page, the time for which the mouse arrow hovers over the area associated with the commodity is received. If the time for which the mouse arrow hovers over the area associated with the commodity reaches a specific value, it indicates that the user is highly interested in the commodity. The fact that the time for which the mouse arrow hovers over the area associated with the commodity reaches a specific value is seen as a certain operation instruction on the commodity. Similarly, other actions may also be set as operation instructions, therefore they should not be limited herein. Furthermore, it should be noted that receiving an operation instruction sent by the user for the webpage is used as an example to illustrate the following steps and embodiments.

2) Determining whether the operation instruction triggers a preset feedback action or feedback identifier of the webpage.

The purpose of evaluating the operation instruction inputted by the user for the webpage is to filter and standardize operation instructions sent by the user. If the operation instruction sent by the user triggers a preset feedback action or feedback identifier of the webpage, the operation instruction is determined as a feedback operation instruction sent by the user for the current webpage and the feedback operation instruction is received.

If the step of determination is not performed, it cannot be decided if an operation instruction sent by the user is feedback for the shopping website. Additionally, it cannot be determined if an operation instruction sent by the user is feedback for a specific webpage or a specific commodity on the shopping website, resulting in obvious defects.

S102: Load and display, based on the received instructions, a feedback webpage associated with the current webpage.

The webpage (e.g., search result page) provides an interface for the user to browse commodities.

A feedback webpage associated with the search result page provides the user with an interface for providing feedback on the search result page.

It should be noted that the search result page includes content of the following two parts.

The first part is commodity information on the search result page, including pictures, titles, prices, description information, and so on of commodities.

The second part is information related to functions of the search result page (referred to as function information) including: a navigation area, a sorting function, brand navigation in the navigation area, brand information, sorting by sales, and so on.

The commodity information and the function information in the search result page are collectively referred to as elements.

The feedback webpage includes content of the following two parts.

The first part is commodity information on the feedback webpage, including pictures, titles, prices, description information, and so on of commodities.

The second part is function information on the feedback webpage, including: a navigation area, a sorting function, brand navigation in the navigation area, brand information, sorting by sales, and so on.

In order to make a distinction between the commodity information and the function information of the aforementioned search result page and those on the feedback webpage, the commodity information and the function information on the feedback webpage are referred to as elements requiring feedback.

In addition, for any element on the search result page, the user may trigger the element through an interactive action and enter a detail viewing page or purchase page associated with the element. For any element requiring feedback on the feedback webpage, the user may trigger the element requiring feedback through an interactive action and a feedback collection interface associated with the element requiring feedback is generated.

The interactive action may be implemented via any one of the following methods: a mouse action for a PC terminal or a touch action for a touch screen of a mobile terminal. The mouse action for a PC terminal may be actions such as single-clicks or double-clicks; the touch action may be set as actions such as taps or swiping. In addition, other than the mouse action and the touch action, the interactive action may also be implemented via other methods, therefore it is not limited herein.

In this embodiment, the loading and displaying, based on the received instructions, a feedback webpage associated with the current webpage includes the following two steps.

1) Receive, according to the feedback operation instruction, data resources required for loading the feedback webpage.

The data resources are downloaded and received from a Web server by a browser and are used for creating, loading, and displaying the feedback webpage. The data resources include text data, multimedia data, scripts, hyperlink data, etc.

In this embodiment, the data resources are classified into two types.

The first type is data resources associated with elements requiring feedback on the feedback webpage. The second type is background data resources required for loading the feedback webpage, wherein the data resources associated with elements requiring feedback include text data, multimedia data, etc. and the background data resources include: scripts, hyperlinks, etc.

In addition, the data resources may also be read from a local memory storage; or they may also be partially received from the Web server and partially read from the local memory storage. The browser may receive, from the Web server, background data resources associated with elements requiring feedback, therefore the method is not limited herein.

2) Load the data resources and generate the feedback webpage.

In this embodiment, the loading the data resources and generating the feedback webpage is as follows: creating a new webpage in the webpage window of a current webpage (namely, a search result page); loading the data resources based on the new webpage; and generating a feedback webpage associated with the search result page.

In addition, other implementation methods may also be adopted; for example, the data resources are loaded based on the search result page, which is covered with a feedback webpage associated with the search result page. The methods of this embodiment should not be limited herein.

S103: Receive feedback input from a user regarding elements requiring feedback on the feedback webpage.

Elements requiring feedback refers to elements supporting user feedback on the feedback webpage generated in the aforementioned step S102, and elements requiring feedback includes information like a text, an image, and so on appearing on the feedback webpage. The feedback input refers to input of the user for elements requiring feedback; and the input refers to an operation performed by the user on elements requiring feedback through a peripheral such as a mouse, a keyboard, or a terminal; and the operation can be a click operation, an input operation, etc.

The receiving feedback input from a user regarding elements requiring feedback on the feedback webpage includes: first, receiving input from the user regarding elements requiring feedback on the feedback webpage; after receiving the input of the user for elements requiring feedback on the feedback webpage, a determination process is performed on the input to decide whether the input triggers a preset feedback action or feedback identifier of elements requiring feedback. If the input triggers the preset feedback action or feedback identifier of elements requiring feedback, it is determined that the input is the feedback input sent by the user for elements requiring feedback on the feedback webpage and the feedback input is received. If the input does not trigger the preset feedback action or feedback identifier of elements requiring feedback, performing no further processing.

Based on the aforementioned step S102, elements requiring feedback on the feedback webpage include commodity information on the feedback webpage, including pictures, titles, prices, description information, and so on of commodities; and function information on the feedback webpage, including: a navigation area, a sorting function, brand navigation in the navigation area, brand information, sorting by sales, and so on.

Furthermore, regarding the commodity information on the feedback webpage, when the mouse is moved to various elements requiring feedback, different effects are produced for various selections:

a picture of a commodity is selected when the mouse is moved to the picture of the commodity;

a title of a commodity is selected when the mouse is moved to the title of the commodity;

a price of a commodity is selected when the mouse is moved to the price of the commodity; and

an entire area of a commodity is selected when the mouse is moved to a blank area.

For the function information on the feedback webpage, different effects are also produced for various selections when the mouse is moved to different areas: a current commodity brand is selected when the mouse is moved to a certain commodity brand; and the entire brand navigation area is selected when the mouse is moved to a blank area of the navigation area.

The feedback action or feedback identifier refers to a click operation of the user, i.e., a click operation when the user wants to perform a click operation on any item of the commodity information and the function information. For example, when a user performs a click operation on a picture, title, price and a blank area of a commodity, or a navigation area, a sorting function, commodity brand navigation, commodity information, and sorting by sales on the feedback webpage, the click operation triggers a preset feedback operation; and then the click operation is determined as feedback input from the user for a commodity or a navigation on the feedback webpage; and the click action performed by the user is received. In addition, elements requiring feedback and the feedback action or feedback identifier in this step may also be implemented via other methods; the methods of this embodiment should not be limited herein.

S104: Combine elements requiring feedback and the feedback input and generate a feedback collection interface.

The feedback collection interface is used for collecting user feedback.

The feedback includes one or more types of feedback, such as text-type feedback and image-type feedback.

The text-type feedback includes: description information about a commodity or a navigation inputted by the user or one or more feedback options selected from the provided feedback options on the webpage as feedback.

The image-type feedback includes the following: the user takes a screenshot of a commodity or of a navigation requiring feedback and uses the screenshot as feedback; or the user marks a commodity or navigation area requiring feedback with the mouse and uses the marked webpage as feedback.

In addition, feedback also includes information that combines both text-type feedback and image-type feedback, or feedback may be a video or an action.

In accordance with the aforementioned feedback, the feedback collection interface may include various representations: a feedback collection interface providing users a text-type feedback input; a feedback collection interface providing users an image-type feedback input; and a feedback collection interface providing a video or an action as feedback input.

It should be noted that in this embodiment, the shopping website collects user feedback through a webpage window. That is, the feedback collection interface is specifically embodied as a webpage window, and the webpage window is referred to as a feedback collection page.

Furthermore, the user feedback may be text-type feedback.

The method of creating the feedback collecting page is as follows: creating a new webpage according to a current webpage window; loading and displaying the feedback collecting page based on the new webpage; and using the feedback collecting page as the feedback collection interface.

In addition, the feedback collection interface may also be implemented via other manners other than the method described in this embodiment. Examples include:

Creating a new webpage window; creating a new webpage according to the webpage window; loading and displaying the feedback collecting page based on the new webpage; and using the feedback collecting page as the feedback collection interface;

Alternatively, loading, based on the feedback webpage or the current webpage, a webpage as the feedback collection page, and using the feedback collecting page as the feedback collection interface; and the method is not limited herein.

S105: Receive the user feedback via the feedback collection interface, and collect on-site information while receiving the user feedback.

The on-site information includes user information and environment information of the page when receiving the user feedback. The user information includes a user ID and the time when the feedback is inputted by the user. The environment information of the page includes users' operating system information and/or browser information.

After combining elements requiring feedback and the feedback input and generating the feedback collection interface, this step also includes receiving the user feedback via the feedback collection interface and collecting the on-site information when the feedback is received. In this embodiment, the on-site information includes a user ID, feedback time, users' operating system information, and browser information.

After receiving the feedback and collecting the on-site information when the feedback is received, the feedback and the on-site information are submitted to a feedback processing end.

The submitting the feedback and the on-site information to a feedback processing end includes the following two steps. First, receive a submission request sent by the user for the feedback, and submit the feedback and the on-site information to the feedback processing end, wherein the feedback processing end is configured to receive and process the feedback. Next, disable the feedback collection interface.

In this embodiment, after the feedback and the on-site information are submitted to the feedback processing end, the feedback collection window is automatically disabled; that is, a search result page associated with the feedback webpage is displayed.

In addition, disabling the feedback collection interface may also be implemented via the following manner: after submitting the feedback and the on-site information to the feedback processing end, if an interface disabling request sent by the user is received and the interface disabling request triggers a preset disabling action or disabling identifier of the feedback collection interface, disabling the feedback collection interface.

An embodiment of the apparatus for collecting user feedback on webpages is as follows:

A method of collecting user feedback of webpages is provided in the aforementioned embodiment, and accordingly, the disclosure further provides an apparatus for collecting user feedback on webpages.

The apparatus in this embodiment is basically similar to the method in the previous embodiment, and thus the description in this embodiment is provided in a concise manner. References can be made for relevant parts by referring to the corresponding description of the method in the previous embodiment. The apparatus in this embodiment described below is merely exemplary.

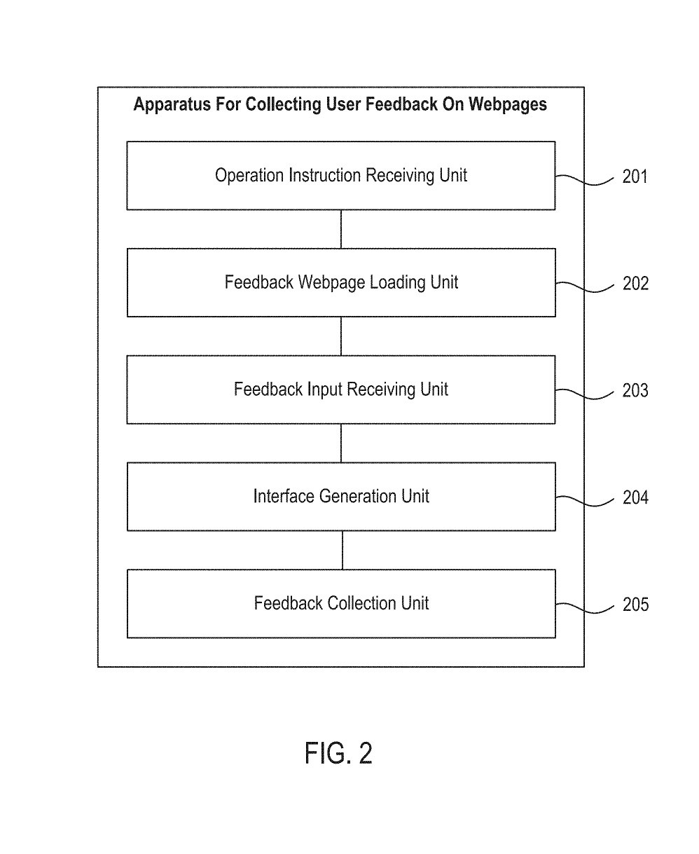

FIG. 2 is a block diagram illustrating an apparatus for collecting user feedback on webpages according to some embodiments of the disclosure.

The illustrated apparatus for collecting user feedback on webpages includes: an operation instruction receiving unit 201, configured to receive a feedback operation instruction on a current webpage; a feedback webpage loading unit 202, configured to load and display, based on the feedback input, a feedback webpage associated with the current webpage; a feedback input receiving unit 203, configured to receive feedback input from a user regarding elements requiring feedback on the feedback webpage; an interface generation unit 204, configured to combine elements requiring feedback and the feedback input and generate a feedback collection interface; and a feedback collection unit 205, configured to receive the user feedback via the feedback collection interface, and collect on-site information while receiving the user feedback.

Optionally, the operation instruction receiving unit 201 may include: an operation instruction receiving subunit, configured to receive an operation instruction for the webpage; an operation instruction judging subunit, configured to: judge whether the operation instruction triggers a preset feedback action or feedback identifier of the webpage; and if the operation instruction triggers the preset feedback action or feedback identifier of the webpage, move to a feedback operation instruction receiving subunit, the feedback operation instruction receiving subunit configured to determine the operation instruction as a feedback operation instruction sent by the user for the current webpage and receive the feedback operation instruction.

Optionally, the feedback input receiving unit 203 may include: an input receiving subunit, configured to receive input from the user regarding elements requiring feedback on the feedback webpage; an input judging subunit, configured to judge whether the input triggers a preset feedback action or feedback identifier of elements requiring feedback; and if the input triggers the preset feedback action or feedback identifier of elements requiring feedback, move to a feedback input receiving subunit, the feedback input receiving subunit configured to determine the input as feedback input from the user regarding elements requiring feedback on the feedback webpage and receive the feedback input.

Optionally, the apparatus for collecting user feedback on webpages may include a feedback submission unit, configured to submit the feedback and the on-site information to a feedback processing end.

Optionally, the feedback submission unit may include: an information submission subunit, configured to receive a submission request sent by the user for the feedback, and submit the feedback and the on-site information to the feedback processing end; and an interface disabling subunit, configured to disable the feedback collection interface.

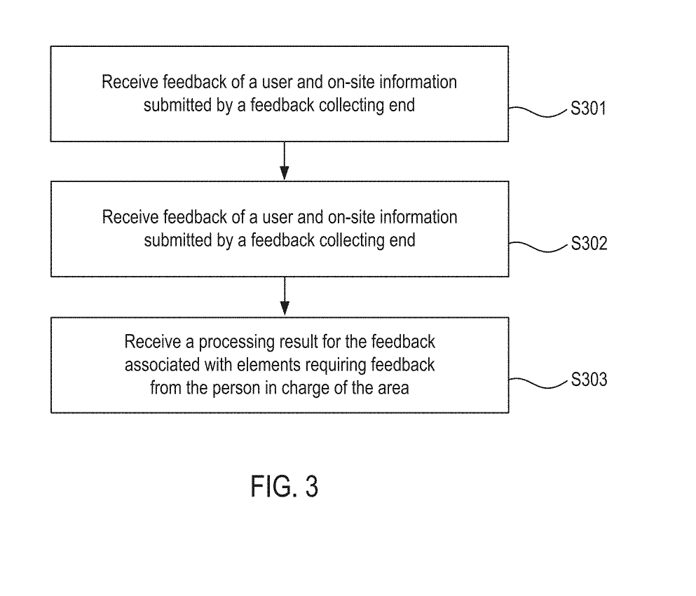

An embodiment of the method for processing user feedback on webpages is illustrated in more detail in connection with FIG. 3.

FIG. 3 is a flow diagram illustrating a method for processing user feedback on webpages according to some embodiments of the disclosure.

A feedback processing end described in this embodiment corresponds to the feedback collecting end for collecting user feedback described in the method of the aforementioned embodiment. References may be made to the method of collecting user feedback of webpages in the previous embodiment when reading this embodiment.

A method for processing user feedback on webpages described in this embodiment includes the following steps:

S301: Receive feedback of a user and on-site information submitted by a feedback collecting end.

Feedback and on-site information submitted by the feedback collecting end are received; and the on-site information includes: a user ID, feedback time, users' operating system information, and browser information.

After receiving the feedback and the on-site information submitted by a feedback collecting end, it is determined whether a format of the feedback conforms to a preset format standard and/or whether the feedback matches elements requiring feedback. If the format of the feedback conforms to the preset format standard and/or the feedback matches elements requiring feedback, a most precise area where elements requiring feedback associated with the feedback is located and a person responsible for the area are determined. Alternatively, if the format of the feedback does not conform to the preset format standard and/or the feedback does not match elements requiring feedback, it is determined that the feedback is invalid.

In one embodiment, after the feedback and the on-site information submitted by the feedback collecting end are received, the validity of the feedback is evaluated by, for example, determining whether the input of the user is null or whether a format of the feedback input by the user is correct;. If the input of the user is null or the format of the feedback input by the user is incorrect, the feedback is determined as invalid feedback and is not processed. Alternatively, if the input of the user is not null and the format of the feedback input by the user is correct, a most precise area where elements requiring feedback associated with the feedback is located and a person responsible for the area are determined.

S302: Determine a most precise area where elements requiring feedback associated with the feedback is located and a person responsible for the area.

It should be noted that in this embodiment that elements requiring feedback associated with the feedback are determined; next, a most precise area where elements requiring feedback is located is determined; and finally, a person responsible for the area is determined.

For example,

a person in charge of an area designated for an entire webpage is A;

a person in charge of an area designated for a navigation area is B;

a person in charge of an area designated for a sorting function is C;

a person in charge of an area designated for a commodity brand in the navigation area is D;

a person in charge of an area designated for commodity information is E; and

a person in charge of an area designated for a sorting by sales function is F.

When determining a most precise area where elements requiring feedback is located and if elements requiring feedback refers to a specific commodity brand in the navigation area, then the first person responsible for the area for the commodity brand, according to the correspondence above, is D; second, the person responsible for the area may also be B because the commodity brand is in the range of the navigation area; and finally, the person responsible for the area for the commodity brand may also be A, because A is the person in charge of the entire webpage.

The principle used by the feedback processing end in determining a person in charge of an area associated with elements requiring feedback is giving priority to a person in charge of a more precise area. That is, in the case that the person responsible for the area associated with the commodity brand may be D, B, and A, under the principle of giving priority to a person in charge of a more precise area, the person responsible for the area is determined to be D because D is responsible for the area where elements requiring feedback is most precisely located.

For the current flow of processing user feedback, the classification of feedback is of great importance in the entire feedback processing process yet is also the bottleneck in improving efficiency in the feedback processing process. If the feedback submitted by the feedback collecting end cannot be correctly classified after the feedback is received, the risk of errors in feedback processing gets higher as services are continuously increasing, leading to an erroneous feedback processing or untimely processing. In this embodiment, the method of determining both a most precise area where elements requiring feedback associated with the feedback is located and a person responsible for the area improves not only the processing efficiency for feedback, but it also achieves a more accurate processing of feedback.

S303: Receive a processing result for the feedback associated with elements requiring feedback from the person responsible for the area.

After determining both the most precise area where elements requiring feedback associated with the feedback is located and a person responsible for the area according to the aforementioned step S302, the person responsible for the area processes the feedback associated with elements requiring feedback to generate a processing result of the feedback associated with elements requiring feedback; the feedback processing end receives the processing result of the feedback associated with elements requiring feedback and sends the processing result to the user by email based on the feedback and the on-site information.

A method for processing user feedback on webpages is provided in the aforementioned embodiment; accordingly, the disclosure further provides an apparatus for processing user feedback on webpages as discussed herein. The apparatus may perform operations similar to the method described in the illustrated embodiment in FIG. 3, and thus the description in this embodiment is provided in a concise manner. References can be made for relevant parts by referring to the corresponding description of the method in the previous embodiment. The apparatus described in this embodiment is merely exemplary in what follows.

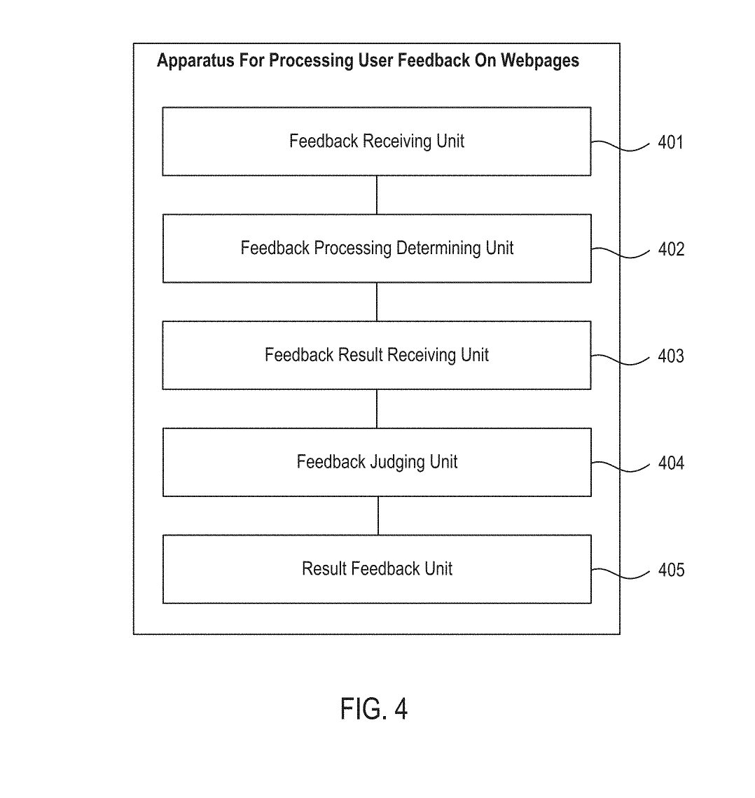

FIG. 4 is a block diagram illustrating an apparatus for processing user feedback on webpages according to some embodiments of the disclosure.

As illustrated FIG. 4, an apparatus for processing user feedback on webpages described in the disclosure includes: a feedback receiving unit 401, configured to receive feedback of a user and on-site information submitted by a feedback collecting end; a feedback processing determining unit 402, configured to determine a most precise area where elements requiring feedback associated with the feedback are located and a person responsible for the area; and a feedback result receiving unit 403, configured to receive a processing result for the feedback associated with elements requiring feedback from the person responsible for the area.

Optionally, the illustrated apparatus may include: a feedback judging unit 404, configured to judge whether a format of the feedback conforms to a preset format standard and/or whether the feedback matches elements requiring feedback; and if the format of the feedback conforms to the preset format standard and/or the feedback matches elements requiring feedback, move to the feedback processing determining unit.

Optionally, the illustrated apparatus may include a result feedback unit 405, configured to combine the feedback and the on-site information and send the processing result to the user by email.

An embodiment of the system for collecting and processing user feedback on webpages is as follows.

A method of collecting user feedback of webpages and a method for processing user feedback on webpages are provided in the aforementioned embodiments; accordingly, an apparatus for collecting user feedback on webpages and an apparatus for processing user feedback on webpages are further provided; in addition, the disclosure provides a system for collecting and processing user feedback on webpages.

The example of the system in this embodiment is similar to the apparatus for collecting user feedback on webpages and the apparatus for processing user feedback on webpages in the aforementioned embodiments, and thus the description in this embodiment is provided in a concise manner. References can be made for relevant parts by referring to the corresponding description of the methods in the previous embodiments. The system in this embodiment is described below and is merely exemplary.

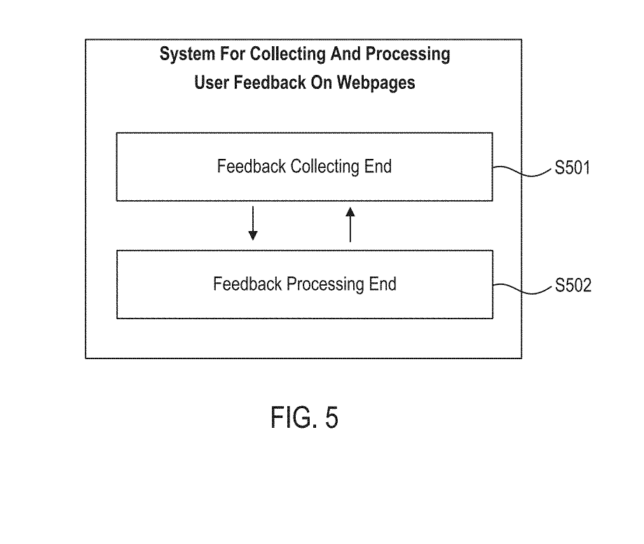

FIG. 5 is a block diagram illustrating a system for collecting and processing user feedback on webpages according to some embodiments of the disclosure.

The illustrated system for collecting and processing user feedback on webpages includes: a feedback collecting end S501, including the apparatus for collecting user feedback on webpages as described above; and a feedback processing end S502, including the apparatus for processing user feedback on webpages as described above.

The disclosure has been disclosed above through embodiments, but is not intended to be limited thereto. Possible variations and modifications can be made by those skilled in the art without departing from the spirit and scope of the disclosure. Therefore, the protection scope of the disclosure shall be defined by the claims of the disclosure.

In a typical configuration, a computing device includes one or more processors (CPUs), input/output interfaces, network interfaces, and memories.

A memory may include a volatile memory in a computer-readable medium, a random-access memory (RAM), and/or a non-volatile memory, such as a read-only memory (ROM) or a flash RAM. A memory is an example of a computer-readable medium.

A computer-readable medium includes a non-volatile medium, a volatile medium, a mobile medium or an immobile medium, which may implement information storage by means of any method or technology. Information may be a computer-readable instruction, a data structure, a module of a program, or other data. Examples of computer storage media include, but are not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc-read only memory (CD-ROM), a digital versatile disc (DVD) or other optical memories, a cartridge magnetic tape, a magnetic tape or magnetic disk memory or other magnetic storage devices or any other non-transmission media, which may be configured to store information that can be accessed by a computing device. As defined herein, computer-readable media do not include transitory computer-readable media (transitory media), such as modulated data signals and carriers.

Those skilled in the art should realize that an embodiment of the disclosure may be provided as a method, a system, or a computer program product. Therefore, the disclosure may use forms of a full hardware embodiment, a full software embodiment, or an embodiment combining software and hardware aspects. Furthermore, the disclosure may use forms of computer program products implemented on one or more computer storage media (including but not limited to a magnetic disk memory, a CD-ROM, an optical memory or the like) which include a computer program code.

1-26. (canceled)

27. A method comprising:
receiving a feedback instruction on a current webpage;
displaying a feedback webpage in response to receiving the feedback instruction, the feedback webpage including elements requiring feedback;
receiving feedback input associated with the elements requiring feedback from a user via the feedback webpage, wherein the feedback input includes a user interaction with at least one of the elements requiring feedback;
generating a feedback collection interface for collecting user feedback based on the elements requiring feedback and the feedback input;
collecting on-site information while collecting the user feedback; and
transmitting the user feedback and on-site information to a feedback processing end via the feedback collection interface.

28. The method of claim 27, wherein receiving a feedback instruction on a current webpage comprises:
detecting an operation instruction on the current webpage, wherein the operation instruction comprises user interaction with the current webpage; and
determining that the operation instruction is a feedback instruction if the operation instruction triggers a preset feedback action or feedback identifier of the current webpage

29. The method of claim 27, wherein displaying a feedback webpage comprises:
retrieving data resources associated with the feedback webpage in response to the feedback instruction; and
loading the data resources to generate the feedback webpage.

30. The method of claim 29 wherein the data resources comprise one or more of text data resources, multimedia data resources, script resources, hyperlink data resources.

31. The method of claim 29 wherein the data resources include data resources associated with elements requiring feedback on the feedback webpage and background data resources.

32. The method of claim 29, wherein retrieving data resources associated with the feedback webpage comprises retrieving data resources from a local memory or from a Web server.

33. The method of claim 29, wherein loading the data resources to generate the feedback webpage comprises one of creating a new webpage based on the data resources or displaying the data resources within the current webpage.

34. The method of claim 27, wherein receiving feedback input from a user associated with the elements requiring feedback comprises:
receiving input from a user regarding elements requiring feedback on the feedback webpage;
determining whether the input triggers a preset feedback action or feedback identifier of the elements requiring feedback; and
interpreting the input as feedback input if the input triggers the preset feedback action or feedback identifier of elements requiring feedback.

35. The method of claim 27, further comprising:
determining an area where the elements requiring feedback associated with the user feedback are located and determining a person responsible for the area; and
receiving a processing result for the feedback from the person responsible for the area.

36. The method of claim 35 wherein determining an area comprises selecting an area from a plurality of overlapping areas containing the elements requiring feedback associated with the user feedback.

37. An apparatus comprising:
one or more processors; and
a non-transitory memory storing computer-executable instructions therein that, when executed by the processors, cause the apparatus to:
receive a feedback instruction on a current webpage;
display a feedback webpage in response to receiving the feedback instruction, the feedback webpage including elements requiring feedback;
receive feedback input associated with the elements requiring feedback from a user via the feedback webpage, wherein the feedback input includes a user interaction with at least one of the elements requiring feedback;
generate a feedback collection interface for collecting user feedback based on the elements requiring feedback and the feedback input;
collect on-site information while collecting the user feedback; and
transmit the user feedback and on-site information to a feedback processing end via the feedback collection interface.

38. The apparatus of claim 37, wherein the instructions causing the apparatus to receive a feedback instruction on a current webpage further include instructions causing the apparatus to:
detecting an operation instruction on the current webpage, wherein the operation instruction comprises user interaction with the current webpage; and
determining that the operation instruction is a feedback instruction if the operation instruction triggers a preset feedback action or feedback identifier of the current webpage

39. The apparatus of claim 37, wherein the instructions causing the apparatus to display a feedback webpage further include instructions causing the apparatus to:
retrieving data resources associated with the feedback webpage in response to the feedback instruction; and
loading the data resources to generate the feedback webpage.

40. The apparatus of claim 39 wherein the data resources comprise one or more of text data resources, multimedia data resources, script resources, hyperlink data resources.

41. The apparatus of claim 39 wherein the data resources include data resources associated with elements requiring feedback on the feedback webpage and background data resources.

42. The apparatus of claim 39, wherein the instructions causing the apparatus to retrieve data resources associated with the feedback webpage further include instructions causing the apparatus to retrieve data resources from a local memory or from a Web server.

43. The apparatus of claim 39, wherein the instructions causing the apparatus to load the data resources to generate the feedback webpage further include instructions causing the apparatus create a new webpage based on the data resources or display the data resources within the current webpage.

44. The apparatus of claim 37, wherein the instructions causing the apparatus to receive feedback input from a user associated with the elements requiring feedback further include instructions causing the apparatus to:
receive input from a user regarding elements requiring feedback on the feedback webpage;
determine whether the input triggers a preset feedback action or feedback identifier of the elements requiring feedback; and
interpret the input as feedback input if the input triggers the preset feedback action or feedback identifier of elements requiring feedback.

45. The apparatus of claim 37 wherein the on-site information includes a user ID, feedback time, user operating system information, and/or browser information

46. A system comprising:
a feedback collection processor configured to:
receive a feedback instruction on a current webpage;
display a feedback webpage in response to receiving the feedback instruction, the feedback webpage including elements requiring feedback;
receive feedback input associated with the elements requiring feedback from a user via the feedback webpage, wherein the feedback input includes a user interaction with at least one of the elements requiring feedback;
generate a feedback collection interface for collecting user feedback based on the elements requiring feedback and the feedback input;
collect on-site information while collecting the user feedback; and
transmitting the user feedback and on-site information to a remote feedback processor via the feedback collection interface; and
a remote feedback processor configured to:
determine an area where the elements requiring feedback associated with the user feedback are located and determining a person responsible for the area; and
receive a processing result for the feedback from the person responsible for the area.
